(19) United States
(12) Patent Application Publication
(10) Pub. No.: US 2026/0171466 A1
(43) Pub. Date: Jun. 18, 2026

(54) Battery Pack for a Machining System, Machining System, and Method for Producing a Battery Pack

(71) Applicant: Andreas Stihl AG & Co. KG, Waiblingen (DE)

(72) Inventor: Holger LOCHMANN, Waiblingen (DE)

(21) Appl. No.: 19/419,227

(22) Filed: Dec. 15, 2025

(30) Foreign Application Priority Data
Dec. 16, 2024 (DE) 10 2024 138 076.4
Dec. 16, 2024 (DE) 10 2024 138 077.2

(51) Int. Cl. H01M 10/04; B27B 17/08; H01M 10/613; H01M 10/6235; H01M 10/656; H01M 50/247

(52) U.S. Cl. CPC H01M 10/0481; H01M 10/613; H01M 10/6235; H01M 10/656; H01M 50/247; B27B 17/08; H01M 2220/30

(57) ABSTRACT

A battery pack for a machining system has a cell assembly, a housing interior for holding the cell assembly, and a housing delimiting the housing interior. The cell assembly has a pretensioning device. The pretensioning device is designed to generate a pretensioning force acting on a solid-state battery cell of the cell assembly such that the pretensioning force does not fall below a specified minimum value when the housing expands relative to the cell assembly.

### CROSS REFERENCE TO RELATED APPLICATIONS

This application claims priority under 35 U.S.C. § 119 from German Patent Application No. 10 2024 138 077.2, filed Dec. 16, 2024, and German Patent Application No. 10 2024 138 076.4, filed Dec. 16, 2024, the entire disclosures of which are herein expressly incorporated by reference.

### BACKGROUND AND SUMMARY

The invention relates, in particular with multiple aspects of the invention, to a battery pack for a machining system. In addition, the invention relates to such a machining system and to a method for producing such a battery pack.

The object of the present invention is to provide a battery pack for a machining system and such a machining system, and a method for producing such a battery pack, which in particular in each case have particular properties. In particular, it is intended that undesired effects of heating of the battery pack are counteracted.

This object is achieved by the subject matter of the independent claims. Preferred embodiments are the subject matter of the dependent claims. The wording of all the claims is made by explicit reference to the content of the description in this document.

Aspects of the invention mentioned above and/or below can be realized individually or jointly. A battery pack according to one of the aspects of the invention can in this respect where appropriate also be further configured according to another aspect of the invention. In particular, the aspects of the invention can be implemented in the same battery pack.

Embodiments of the invention—unless explicitly specified as being separate or excluded for another reason—can be based in principle on any of the aspects of the invention per se or on a combination of the aspects of the invention. In particular, the same applies in terms of expedient specifications.

A battery pack according to a first aspect of the invention is suitable for use in a machining system. In particular, the battery pack is designed and/or configured for use in the machining system. The battery pack has a cell assembly which has at least one electric solid-state battery cell for storing electrical energy. The at least one solid-state battery cell can be designed in particular substantially to be plate-shaped. The battery pack has a housing interior. The housing interior is designed to hold the cell assembly. The battery pack has a housing which delimits the housing interior in particular at least partially and/or completely. The housing can surround the housing interior at least partially and/or completely. The cell assembly has a pretensioning device. The pretensioning device is designed to generate a pretensioning force in such a way that the pretensioning force acts on the at least one solid-state battery cell of the cell assembly, in particular in compression. The pretensioning force is generated here by means of the pretensioning device in such a way that, when the housing expands relative to the cell housing, the pretensioning force does not fall below a specified minimum value. Such expansion, as a result of which the pretensioning force does not fall below a minimum value, can be thermal expansion of the housing. In particular, the pretensioning force can be generated in such a way that it does not fall below the specified minimum value when the housing, in particular as a result of heating, expands more than the at least one solid-state battery cell. In this respect, the pretensioning device can be designed to generate the pretensioning force in such a way that the pretensioning force is maintained even when the housing experiences greater thermal expansion than the at least one solid-state battery cell. In this way, the at least one solid-state battery cell is held under compression when the battery pack is heated. The heating can be caused by discharging the at least one solid-state battery cell and/or by charging the at least one solid-state battery cell. Alternatively or additionally, the heating can be caused by the external influence of heat.

The battery pack can expediently have only one solid-state battery cell or at least two, in particular a plurality of, solid-state battery cells.

The at least one solid-state battery cell can be a solid-state accumulator cell.

The at least one solid-state battery cell has in particular two electrodes and an electrolyte, wherein the electrodes and the electrolyte are made from a solid material. In particular, the electrolyte is solid under standard conditions, more particularly is thus not liquid and/or gaseous. Polymer, sulfide or oxide electrolytes can be used.

The at least one solid-state battery cell can expediently operate in stable fashion at significantly higher temperatures or within wider temperature ranges than battery cells of a different, in particular conventional, type. Because of such higher temperatures or such wider temperature ranges, thermal expansion effects can in the present case be greater than in the case of conventional battery packs with conventional battery cells. As a consequence of such higher temperatures or wider temperature ranges, the pressure which is to be built up or maintained by the frame and/or housing can be subject to large fluctuations which can be counteracted by the provision of the pretensioning device.

In the present context, operating temperatures of the at least one solid-state battery cell of −35° C. to 200° C. are expediently conceivable.

Contact of the electrolyte of the solid-state battery cell with the electrodes of the solid-state battery cell can expediently be maintained particularly reliably by applying a reduced pressure to the at least one solid-state battery cell. By means of the pretensioning force, a pressure can be built up or maintained over a frame of the solid-state battery cell and/or over the housing. In particular, the pretensioning force acts here in such a way that the electrolyte and the electrodes are pressed against and/or onto each other, in particular perpendicularly to contact surfaces between the electrolyte and the electrodes.

Because the pretensioning device is provided, it is expediently possible to dispense with at least one pressure sensor present in conventional battery packs, in particular all the pressure sensors, for monitoring the contact pressure of the electrodes at the electrolyte.

Because the pretensioning device is provided, it is expediently possible for a battery management system of the battery pack to be designed at least significantly more simply than conventional battery packs, or even to be missing altogether.

In an embodiment of the invention, in particular at least based on the first aspect of the invention, the pretensioning device has at least one resilient element which is designed to generate the pretensioning force. The resilient element can in particular be deformed elastically in order to generate the pretensioning force depending on the deformation. The resilient element can expediently serve to compensate thermal expansion [0017] effects.

The pretensioning device is expediently designed such that the pretensioning force either remains virtually constant and/or does not depart from an intended value range over typical thermal expansion distances of the at least one solid-state battery cell or of the housing such that the pressure of the housing on the cells always reaches a minimum amount. In particular, it is intended that the fluctuations of the pretensioning force remain within a predetermined range, more particularly even if the pretensioning force should decrease somewhat in the case of temperature expansion. Such a decrease can in particular already be taken into account when pressure and/or pretensioning force is initially applied to the at least one solid-state battery cell as a consequence of the production process.

In a further embodiment of the invention, in particular at least based on the first aspect of the invention, the battery pack has two contact plates which serve to transmit the pretensioning force. A resilient element of the pretensioning device, in particular the abovementioned resilient element, is sandwiched here between the two contact plates. The contact plates can enable particularly uniform distribution of a pressure, dependent on the pretensioning force, on the at least one solid-state battery cell.

A respective contact plate can expediently have an in particular sheet-metal element. Alternatively or additionally, a respective contact plate can have a flat polymer element. A respective contact plate can be designed as electrically conductive or electrically insulating.

At least one of the contact plates can expediently be designed separately from the relevant solid-state battery cell, in particular as a constituent part of a plate heat exchanger of the battery pack. Alternatively or additionally, at least one of the contact plates can be designed as part of a wall of the relevant solid-state battery cell.

At least one, in particular each, of the contact plates can expediently be designed as flatly and/or without inner cooling ducts.

In a further embodiment of the invention, in particular at least based on the first aspect of the invention, at least one contact plate of the battery pack, in particular at least one of the abovementioned contact plates, has a curvature and/or a structuring and/or a profiling for the uniform distribution of pressure at a contact side of the relevant contact plate. The contact side of at least one contact plate can be designed to be placed against the at least one solid-state battery cell.

At least one of the contact plates can expediently have a bulge. The relevant contact plate can have a trough-like shape or a bowl-like shape. The relevant contact plate can have a concave and a convex side which are arranged opposite each other along a thickness direction of the relevant contact plate. The pretensioning device here can touch the relevant contact plate either at the concave side or at the convex side, in particular with surface contact, more particularly with full surface contact.

The curvature of at least one contact plate can expediently face the at least one solid-state battery cell. In particular, a convex side of the curved plate can face in the direction of the relevant solid-state battery cell. In particular, because of the curvature, the pressure can desirably be distributed uniformly over the solid-state battery cell.

In a further embodiment of the invention, in particular at least based on the first aspect of the invention, a resilient element of the pretensioning device, in particular the abovementioned resilient element, has a corrugated structure or is such a corrugated structure. The resilient element can have an undulating shape. The corrugated structure can have or be a corrugated profile, in particular in the manner of a corrugated sheet. In particular, the resilient element is designed and arranged such that the pretensioning force is generated along an amplitude direction of the corrugated structure.

In a further embodiment of the invention, in particular at least based on the first aspect of the invention, a resilient element of the pretensioning device, in particular the abovementioned resilient element or a different resilient element of the pretensioning device, has a tubular body. In particular, the resilient element is arranged such that the pretensioning force is generated along a radial direction of the tubular body.

In a further embodiment of the invention, in particular at least based on the first aspect of the invention, the battery pack has at least one fluid duct through which temperature-control fluid can flow. The pretensioning device here delimits said at least one fluid duct at least in some regions. At least or only one, in particular strip-shaped, surface region of the pretensioning device can come into contact with the temperature-control fluid flowing through the fluid duct.

A gas, in particular air, and/or a liquid, in particular polyalphaolefin (PAO) and/or hydrofluoroether (HFE) and/or perfluorinated hydrocarbons (PFC), can expediently be used as the temperature-control fluid. It is conceivable to use different temperature-control fluids depending on the situation.

In a further embodiment of the invention, in particular at least based on the first aspect of the invention, the pretensioning device delimits at least two fluid ducts of the battery pack in each case at least, in particular only, in some regions. Alternatively or additionally, temperature-control fluid can flow through two fluid ducts of the battery pack, in particular the abovementioned at least two fluid ducts, either connected in parallel or connected in series.

In a further embodiment of the invention, in particular at least based on the first aspect of the invention, the cell assembly has at least two solid-state battery cells. The at least two solid-state battery cells are arranged here spaced apart from each other along a stacking direction of the cell assembly such that the at least two solid-state battery cells flank a cell intermediate space of the cell assembly. The pretensioning device is arranged here between the two solid-state battery cells which flank the cell intermediate space such that contact sides of the pretensioning device which are situated opposite each other along the stacking direction in each case touch one of these two solid-state battery cells. The pretensioning device can project all the way through the cell intermediate space along the stacking direction.

The amplitude direction of the abovementioned corrugated structure can expediently run parallel to the stacking direction. Alternatively or additionally, temperature-control fluid can flow through the abovementioned at least one fluid duct of the battery pack, in particular all the fluid ducts of the battery pack, substantially perpendicular to the stacking direction and/or to the amplitude direction.

The thickness direction of at least one of the abovementioned contact plates can expediently run parallel to the stacking direction.

In a further embodiment of the invention, in particular at least based on the first aspect of the invention, the housing has a housing cover which adjoins the housing interior, in particular at the end side. The housing cover can adjoin the housing interior perpendicular to the stacking direction.

In a further embodiment of the invention, in particular at least based on the first aspect of the invention, the housing cover at least partially delimits a fluid distribution space of the battery pack. The fluid distribution space here serves to distribute temperature-control fluid to at least one fluid duct of the battery pack, in particular to the abovementioned at least one fluid duct. In particular, the fluid distribution space serves to distribute temperature-control fluid to at least two fluid ducts of the battery pack, in particular to the abovementioned at least two fluid ducts. Alternatively or additionally, the housing cover or another housing cover of the housing has a fluid collection space through which temperature-control fluid can flow, wherein the housing cover or another housing cover of the housing at least partially delimits the fluid collection space for collecting temperature-control fluid from at least one fluid duct of the battery pack, in particular from the at least one abovementioned fluid duct. In particular, the fluid collection space is designed to collect temperature-control fluid from at least two fluid ducts of the battery pack, in particular from the abovementioned at least two fluid ducts.

The fluid distribution space and the fluid collection space are expediently fluidically connected communicatively by means of at least one fluid duct of the battery pack, in particular by means of at least two fluid ducts of the battery pack.

In a further embodiment of the invention, in particular at least based on the first aspect of the invention, the housing cover has an inlet opening. The inlet opening is designed for the throughflow of temperature-control fluid in order to feed the temperature-control fluid to at least one fluid duct of the battery pack, in particular to the at least one abovementioned fluid duct. Alternatively or additionally, the housing cover or the other housing cover of the housing has an outlet opening for the throughflow of temperature-control fluid in order to discharge temperature-control fluid from the at least one fluid duct of the battery pack, in particular from the abovementioned fluid duct.

In a further embodiment of the invention, in particular at least based on the first aspect of the invention, the housing cover and/or the other housing cover of the housing at least partially, in particular integrally and/or completely, has a deflection device through which temperature-control fluid can flow. The deflection device here has a fluid inlet for the inflow of temperature-control fluid into the deflection device, and a fluid outlet, communicating fluidically with the fluid inlet, for the outflow of temperature-control fluid from the deflection device. At least one fluid duct of the battery pack, in particular the at least one abovementioned fluid duct, is fluidically joined to the fluid outlet of the deflection device. The deflection device is adapted here to deflect temperature-control fluid when it flows through the deflection device in such a way that an outlet temperature gradient of the temperature-control fluid flowing out at the fluid outlet and an inlet temperature gradient of the temperature-control fluid flowing in at the fluid inlet are oriented substantially in the same direction. The deflection device can be adapted to impose a swirl on the temperature-control fluid flowing through it.

The housing can expediently have a shell housing. The shell housing can have two shell housing parts, in particular shell housing halves, which are fastened to each other. The housing cover of the housing and/or another housing cover of the housing can be fastened here, in particular detachably or undetachably, at the end side of the shell housing.

The shell housing parts can expediently be designed as identical parts and/or as L-shaped profile parts. The shell housing and/or at least one of the housing covers can have an, in particular thermoplastic, polymer material or be made from such a polymer material.

A method according to the invention is used to produce a battery pack according to the invention, in particular a battery pack according to at least the first aspect of the invention. The method has a step in which the, in particular preassembled, cell assembly is positioned between two housing parts for the housing of the battery pack. In addition, the method has a step in which the housing parts are joined together in such a way that the housing interior in which the cell assembly positioned between the housing parts is held is at least partially delimited, along with setting of the minimum value for the pretensioning force. The method moreover has a step in which the joined-together housing parts are fastened to each other in such a way that the set minimum value for the pretensioning force is preserved.

The housing parts can expediently be fastened to each other by connecting the housing parts to each other in materially bonded fashion. The materially bonded connection can be effected by adhesive bonding and/or in particular welding without filler metal.

The housing parts can expediently jointly surround the housing interior in the manner of a shell and/or peripherally in their joined-together state and in their fastened-together state.

A battery pack according to a second aspect of the invention is suitable for use in a machining system. In particular, the battery pack is designed and/or configured for use in the machining system. The battery pack has a cell assembly which has at least one electric solid-state battery cell for storing electrical energy. The at least one solid-state battery cell can be designed to be, in particular substantially, plate-shaped. The battery pack additionally has a deflection device for the throughflow of a temperature-control fluid. The deflection device has a fluid inlet for the inflow of temperature-control fluid into the deflection device. The deflection device additionally has a fluid outlet for the outflow of temperature-control fluid from the deflection device. The fluid inlet communicates fluidically with the fluid outlet. The deflection device is adapted here to deflect temperature-control fluid which flows through the deflection device. The temperature-control fluid flowing through the deflection device can be deflected here by means of the deflection device in such a way that an outlet temperature gradient of the temperature-control fluid flowing out at the fluid outlet and an inlet temperature gradient of the temperature-control fluid flowing in at the fluid inlet are oriented substantially in the same direction. As a consequence of the deflection, effected by the deflection device, of the temperature-control fluid when it flows through the deflection device, particularly effective dissipation of heat from the battery pack is enabled by means of the temperature-control fluid. “Dissipation of heat” can mean “cooling”.

In particular, the outlet temperature gradient and the inlet temperature gradient are orthogonal to a main flow direction of the temperature-control fluid flowing through the deflection device. The main flow direction can be defined by a maximum flow rate of a flow profile of the temperature-control fluid flowing through the deflection device.

By deflecting the temperature-control fluid flowing through the deflection device, it can in particular be achieved that, after heat has been absorbed by the temperature-control fluid upstream of the deflection device, a particularly large amount of heat can then be absorbed again by the temperature-control fluid downstream of the deflection device. In other words: the deflection can make it possible to use upstream and downstream of the deflection device in each case different, in particular relatively cold, flow cross section fractions to absorb heat which needs to be removed.

The deflection device can expediently be adapted to impose a swirl on the temperature-control fluid flowing through it.

The deflection device can expediently enable a low-friction flow without eddying, with low shear rates, but nevertheless good mixing of hot and cold fluid fractions of the temperature-control fluid.

In an embodiment of the invention, in particular at least based on the second aspect of the invention, the deflection device has a U-shaped deflection fluid duct through which temperature-control fluid can flow. The deflection fluid duct can connect a top side of the solid-state battery cell to an underside, situated opposite the top side, of the solid-state battery cell.

In a further embodiment of the invention, in particular at least based on the second aspect of the invention, the deflection device has at least one duct wall surface portion which extends in elongated fashion, in particular substantially with a strip and/or band shape, from the fluid inlet to the fluid outlet in an, in particular virtual, U-shaped guide curve of the deflection device. The main flow direction of the temperature-control fluid flowing through the deflection device can run substantially parallel to the guide curve. The duct wall surface portion partially delimits a deflection fluid duct of the deflection device, in particular the abovementioned deflection fluid duct. The duct wall surface portion here has an, in particular at least or only partial, twist between the fluid inlet and the fluid outlet. The twist is designed in such a way that temperature-control fluid flowing through the deflection fluid duct is deflected as a result of the twist in such a way that the outlet temperature gradient and the inlet temperature gradient are oriented substantially in the same direction.

The twist can expediently in the present context be an incomplete twist. In particular, the twist can thus be less than 360°. The twist can in particular be only a half-twist, in particular a twist by 150° to 210°, more particularly by 180°.

In a further embodiment of the invention, in particular at least based on the second aspect of the invention, the deflection device has at least one flow guidance element protruding, in particular in a ridge and/or rib shape, from a duct wall surface of the deflection device. The flow guidance element here serves to guide the temperature-control fluid flowing through the deflection device. The duct wall surface from which the flow guidance element protrudes, in particular in a ridge and/or rib shape, can delimit a deflection fluid duct of the deflection device, in particular the abovementioned deflection fluid duct. The flow guidance element can have an, in particular helical and/or helicoidal, spiral. The spiral can expediently be twisted by less than 360°. The spiral can be twisted only by 150° to 210°, more particularly only by 180°. Such a flow guidance element can be appropriate in particular, but not exclusively, in combination with round duct cross sections.

In a further embodiment of the invention, in particular at least based on the second aspect of the invention, the battery pack has a housing interior for holding the cell assembly and a housing delimiting the housing interior. The cell assembly here has a pretensioning device. The pretensioning device is designed to generate a pretensioning force acting on the solid-state battery cell in such a way that the pretensioning force does not fall below a specified minimum value when the housing expands relative to the cell assembly. The pretensioning device here delimits at least one fluid duct, through which temperature-control fluid can flow, of the battery pack at least in some regions.

In a further embodiment of the invention, in particular at least based on the second aspect of the invention, the pretensioning device has at least one resilient element for generating the pretensioning force.

In a further embodiment of the invention, in particular at least based on the second aspect of the invention, a resilient element of the pretensioning device, in particular the abovementioned resilient element, has a corrugated structure or is a corrugated structure. The corrugated structure here has troughs and crests. The troughs and crests can be arranged so that they alternate and/or can taper, opposed to one another, in particular along an amplitude direction of the corrugated structure. The corrugated structure separates first fluid ducts of the battery pack from second fluid ducts of the battery pack in such a way that the first fluid ducts are defined by the troughs and the second fluid ducts by the crests.

Intermediate spaces between a respective contact plate and the resilient element placed against this contact plate can expediently be used as cooling ducts, in particular as first and/or second fluid ducts through which temperature-control fluid can flow.

In a further embodiment of the invention, in particular at least based on the second aspect of the invention, a resilient element of the pretensioning device, in particular the abovementioned resilient element or another resilient element of the pretensioning device, has a tubular body. The tubular body here defines, in particular with its tubular body inner circumferential side, the at least one fluid duct of the battery pack. In particular, the tubular body has an internal cross section which can be deformed depending on the stress, said internal cross section being either rectangular or elliptical, in particular circular or non-circular, in an undeformed state of the tubular body.

In a further embodiment of the invention, in particular based on at least the second aspect of the invention, the battery pack has two contact plates for transmitting the pretensioning force. The resilient element is sandwiched here between said contact plates. A respective contact plate can, in particular as an alternative or in addition to the resilient element, delimit at least one fluid duct in some regions.

In a further embodiment of the invention, in particular at least based on the second aspect of the invention, a housing of the battery pack has a housing cover which adjoins a housing interior of the battery pack, in particular at the end.

In a further embodiment of the invention, in particular at least based on the second aspect of the invention, the housing cover at least partially delimits a fluid distribution space of the battery pack through which temperature-control fluid can flow, said fluid distribution space being designed to distribute temperature-control fluid to at least one fluid duct, in particular to the at least one abovementioned fluid duct. In particular, the fluid distribution space is designed to distribute temperature-control fluid to at least two fluid ducts of the battery pack, in particular to the abovementioned at least two fluid ducts. Alternatively or additionally, the housing cover or another housing cover of the housing at least partially delimits a fluid collection space of the battery pack through which temperature-control fluid can flow, said fluid collection space being designed to collect temperature-control fluid from the at least one fluid duct, in particular from at least two fluid ducts of the battery pack.

In a further embodiment of the invention, in particular at least based on the second aspect of the invention, the housing cover has an inlet opening for the throughflow of temperature-control fluid which is fed to at least one fluid duct of the battery pack, in particular to the at least one abovementioned fluid duct. Alternatively or additionally, the housing cover or another housing cover of the housing has an outlet opening for the throughflow of temperature-control fluid which is discharged from the at least one fluid duct of the battery pack, in particular to the at least one abovementioned fluid duct.

In a further embodiment of the invention, in particular at least based on the second aspect of the invention, the housing cover and/or another housing cover of the housing has the, in particular abovementioned, deflection device of the battery pack at least partially, in particular integrally and/or completely.

In a further embodiment of the invention, in particular at least based on the second aspect of the invention, the battery pack has at least one further fluid duct through which temperature-control fluid can flow. The at least one fluid duct and the at least one further fluid duct here flank the solid-state battery cell. The at least one fluid duct is fluidically joined to the fluid outlet of the deflection device, whereas the at least one further fluid duct is fluidically joined to the fluid inlet of the deflection device. The at least one fluid duct and the at least one further fluid duct thus fluidically communicate with each other by means of the deflection device.

The at least one fluid duct expediently extends along the at least one solid-state battery cell at the top, whereas the at least one further fluid duct extends along said solid-state battery cell at the bottom.

A machining system according to the invention has a battery pack according to the first aspect of the invention and/or according to the second aspect of the invention. In addition, the machining system has an electric machining unit. The electric machining unit has a holding device for replaceably holding the battery pack. In addition, the electric machining unit has an electric drive device which can be supplied with electrical energy from the at least one solid-state battery cell of the held battery pack. The drive device can serve to supply drive power to a tool which can be fitted onto the electric machining unit. The tool can be designed to cut a workpiece.

Further advantages and features of the invention can be found in the claims and in the following description of preferred exemplary embodiments of the invention which are illustrated on the basis of the drawings. The same reference signs here relate to identical or similar or functionally identical components.

It should be understood that the features mentioned above and which will be explained below can be used not only in the combination specified in each case but also in other combinations or on their own without going beyond the scope of the present invention.

### BRIEF DESCRIPTION OF THE DRAWINGS

FIG. 1 shows a schematic side view of an embodiment of a machining system according to the invention;

FIG. 2 shows a highly schematic view in section of an embodiment of a battery pack according to the invention for the machining system according to FIG. 1;

FIG. 3 shows a highly schematic view in section of a further embodiment of the battery pack according to the invention for the machining system according to FIG. 1;

FIG. 4 shows a highly schematic view in section of a further embodiment of the battery pack according to the invention for the machining system according to FIG. 1 with different types of resilient elements, illustrated in each case in the undeformed state on the left and in their installed, i.e. pretensioned and/or deformed state, on the right;

FIG. 5 shows a highly schematic view of a further embodiment of the battery pack according to the invention for the machining system according to FIG. 1;

FIG. 6 shows a highly schematic view of a further embodiment of the battery pack according to the invention for the machining system according to FIG. 1;

FIG. 7 shows a highly schematic view of a further embodiment of the battery pack according to the invention for the machining system according to FIG. 1;

FIG. 8 shows a highly schematic view of a further embodiment of the battery pack according to the invention for the machining system according to FIG. 1;

FIG. 9 shows a highly schematic perspective exploded view of a further embodiment of the battery pack according to the invention for the machining system according to FIG. 1;

FIG. 10 shows a highly schematic view in section of a deflection device for a further embodiment of the battery pack according to the invention for the machining system according to FIG. 1; and

FIG. 11 shows a highly schematic view in section of a further embodiment of the battery pack according to the invention for the machining system according to FIG. 1.

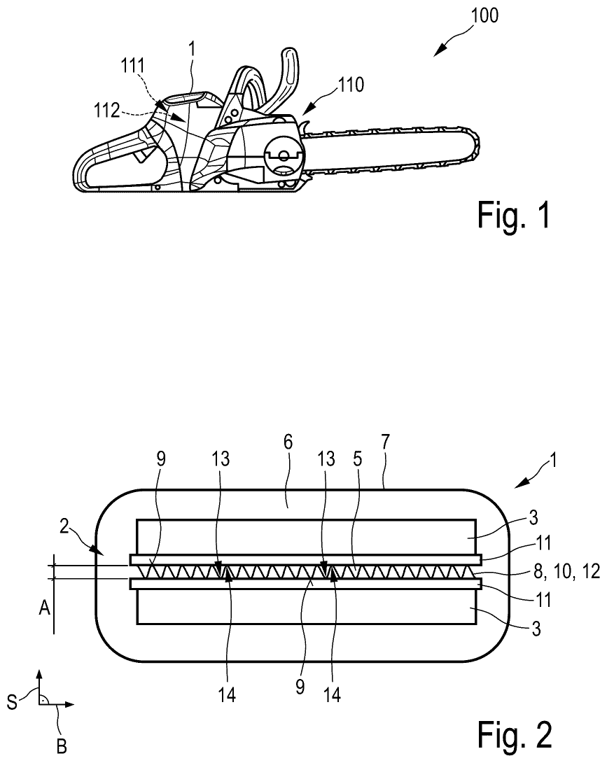

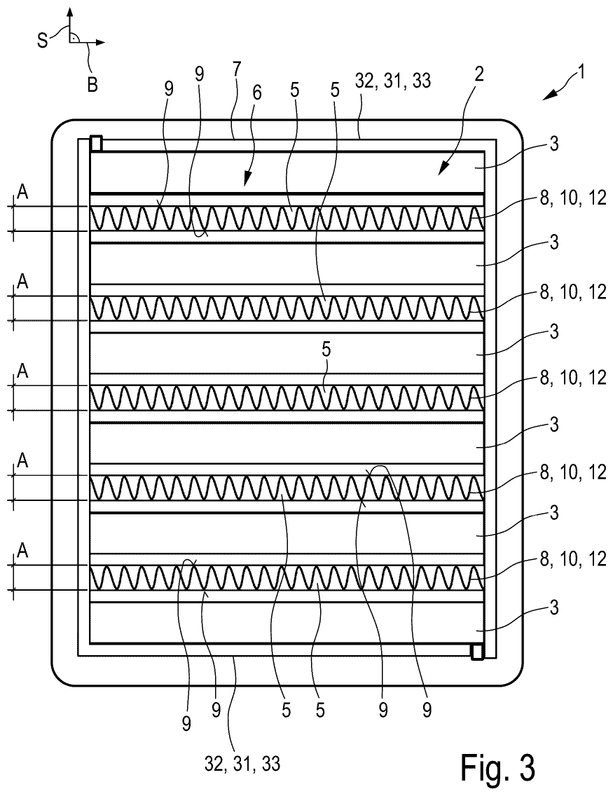

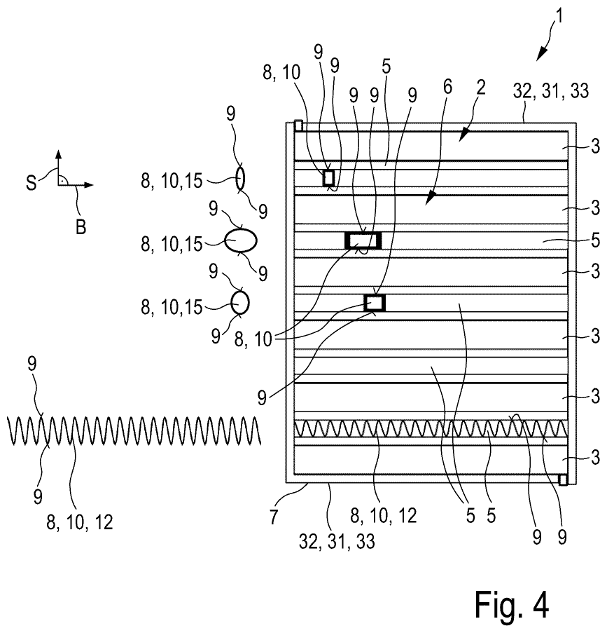

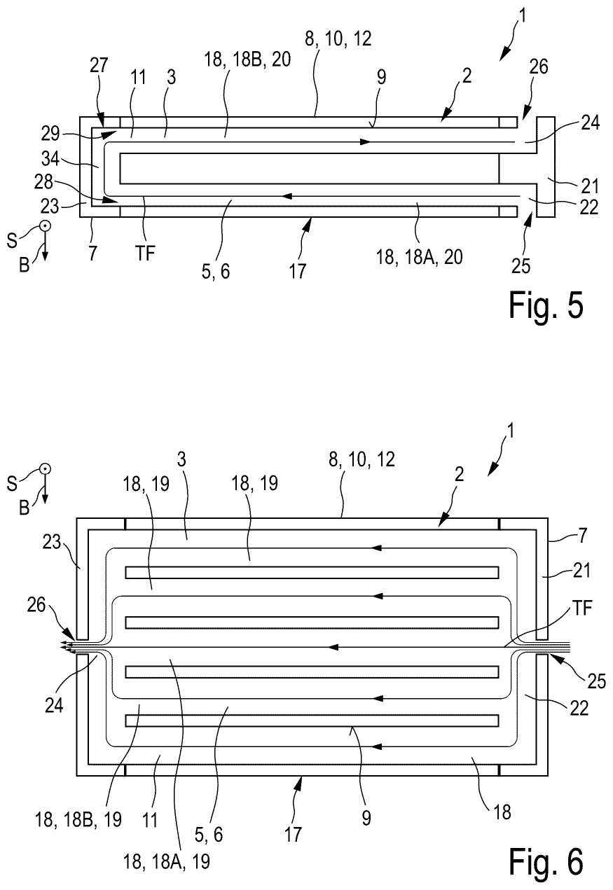

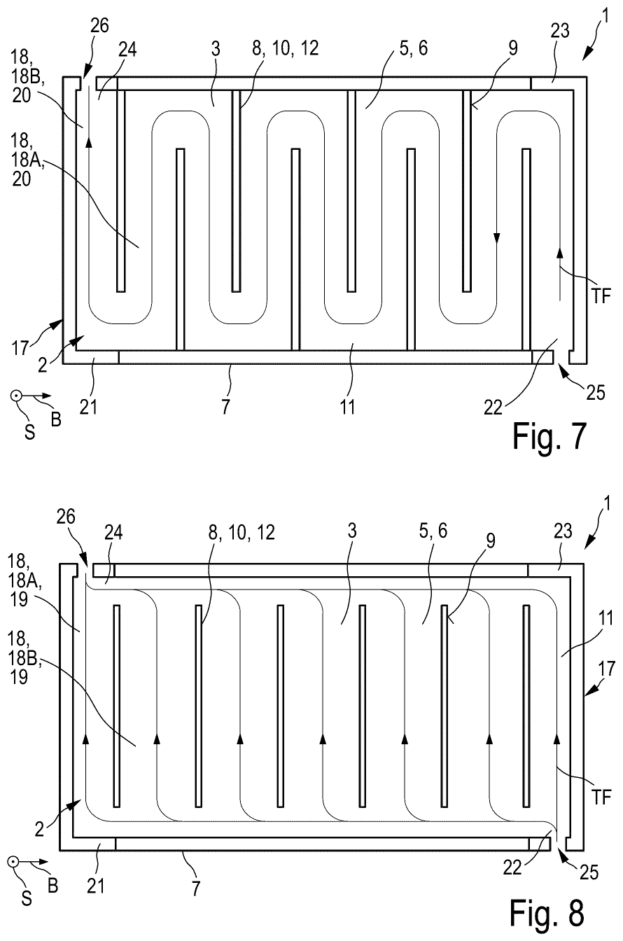

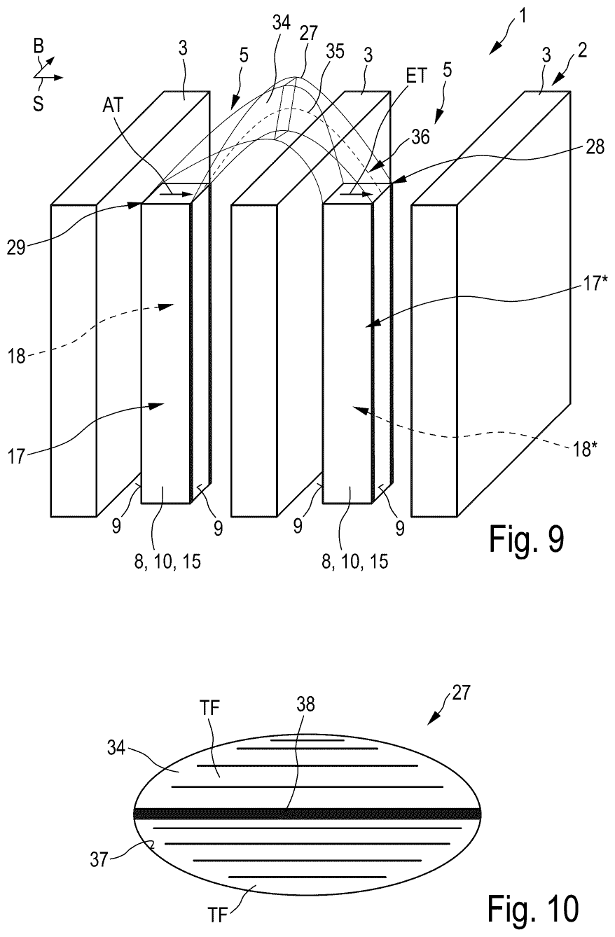

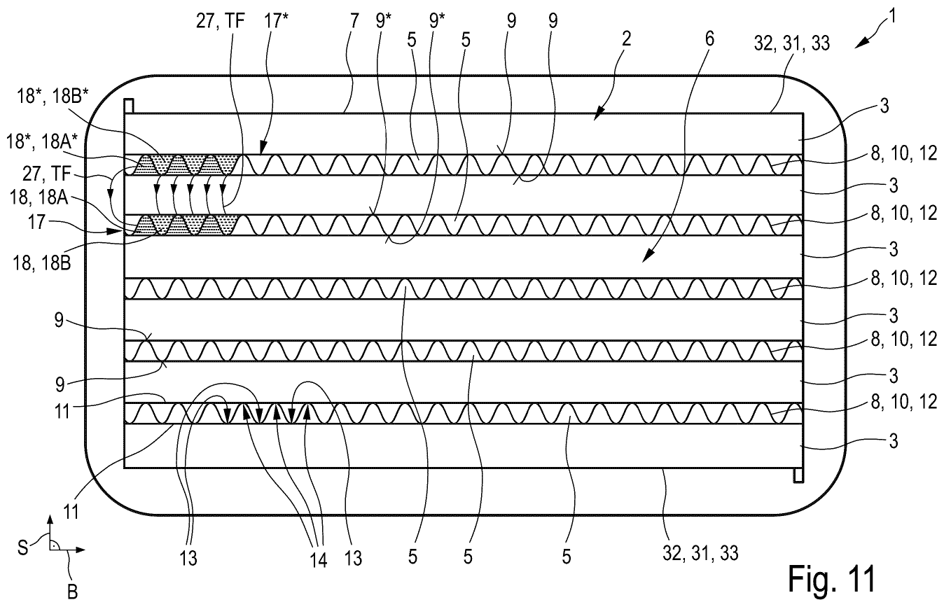

### DETAILED DESCRIPTION OF THE DRAWINGS

A machining system 100 has a battery pack 1. The battery pack 1 is in this respect provided and/or adapted for use in the machining system 100. The machining system 100 has an electric machining unit 110 which is designed, for example, as a motor chainsaw.

The electric machining unit 110 has a holding device 111 which serves to replaceably hold the battery pack 1. The electric machining unit 110 moreover has an electric drive device 112. The electric drive device 112 can be supplied with electrical energy from at least one solid-state battery cell 3 of the held battery pack 1. The drive device 112 serves, for example, to supply a tool of the electric machining unit 110 with drive power for a machining operation, in particular for cutting a workpiece.

The battery pack 1 has a cell assembly 2. The cell assembly 2 has at least one electric solid-state battery cell 3 for storing electrical energy. For example, the cell assembly 2 comprises at least two electric solid-state battery cells 3 for storing electrical energy. The at least two solid-state battery cells 3 can be arranged spaced apart from each other by a distance A along a stacking direction S of the cell assembly 2 in such a way that they flank a cell intermediate space 5 of the cell assembly 2. The cell assembly 2 can have more than two solid-state battery cells 3, wherein a cell intermediate space 5 can be present between in each case two solid-state battery cells 3 which are adjacent to each other along the stacking direction S. The cell assembly 2 can be referred to as a cell stack.

The battery pack 1 has, for example, a housing interior 6 inside which the cell assembly 2 is arranged. In the present case, the battery pack 1 here has a housing 7 which delimits the housing interior 6 holding the cell assembly 2.

The cell assembly 2 has, for example, a pretensioning device 8. The pretensioning device 8 is designed to generate a pretensioning force acting on the at least one solid-state battery cell 3. The pretensioning force can be generated here by means of the pretensioning device 8 in such a way that the pretensioning force does not fall below a specified minimum value when the housing 7 expands relative to the cell assembly 2. In particular, the cell assembly 2 can be held under compression along the stacking direction S by means of the pretensioning device 8, even when the housing 7 expands more than the cell assembly 2—for example as a consequence of heating. The pretensioning device 8 can in this respect be designed to at least partially compensate different thermal expansions of the housing 7 and of the solid-state battery cell 3.

The pretensioning device 8 is, for example, sandwiched in the cell intermediate space 5 between the two solid-state battery cells 3 flanking the cell intermediate space 5 in such a way that contact sides 9 of the pretensioning device 8 which are situated opposite each other along the stacking direction S each touch one of these two solid-state battery cells 3. If the cell assembly 2 has a plurality of cell intermediate spaces 5, a pretensioning device 8 can be arranged in each or only in selected cell intermediate spaces 5 or only in a single cell intermediate space 5.

The cell assembly 2 can be held in the housing interior 6 in such a way that the cell assembly 2 is supported along the stacking direction S on both sides on the housing 7 at least partially receiving the pretensioning force.

The pretensioning device 8 has, for example, at least one resilient element 10 for generating the pretensioning force. In many embodiments, the pretensioning device 8 has precisely one such resilient element 10. In other embodiments, the pretensioning device 8 can have a plurality of resilient elements 10, in particular of the same or different type.

The battery pack 1 has, for example, two contact plates 11, which are in particular thin relative to the at least one solid-state battery cell 3, for transmitting the pretensioning force. The resilient element 10 of the pretensioning device 8 can be sandwiched here between the two contact plates 11. The contact plates 11 can belong to the pretensioning device 8, in particular wherein in each case one of the contact plates 11 forms and/or has, facing away from the resilient element 10 along the stacking direction S, one of the contact sides 9 of the pretensioning device 8.

At least one contact plate 11 of the battery pack 1 has, for example, a curvature for uniform pressure distribution at the respective contact side 9 of this contact plate 11. Alternatively or additionally, at least one contact plate 11 of the battery pack 1 has a structuring for uniform pressure distribution at the respective contact side 9 of this contact plate 11. Alternatively or additionally, at least one contact plate 11 has a profiling for uniform pressure distribution at the respective contact side 9 of this contact plate 11. It should be understood that either only one of the contact plates 11, in particular of the pretensioning device 8, can have a curvature and/or a structuring and/or a profiling, or both the contact plates 11 flanking the resilient element 10 can.

The resilient element 10 of the pretensioning device 8 can have or be, for example, a corrugated structure 12. The corrugated structure 12 can have troughs 13 and crests 14 alternating along a width direction B of the battery pack 1. The troughs 13 can taper in the opposite direction to the stacking direction S. The crests 14 can taper in the stacking direction S. An amplitude direction of the corrugated structure 12 can run parallel to the stacking direction S. For example, the corrugated structure 12 extends-considered along the stacking direction S-essentially with surface contact, in particular over a respective contact side 9.

The resilient element 10 of the pretensioning device 8 has, for example, a tubular body 15, in particular as an alternative or in addition to the corrugated structure 12. The tubular body 15 can extend in elongated fashion perpendicular to the stacking direction S. For example, the tubular body 15 has a rectangular internal cross section in an unstressed state, in particular when no pretensioning force is generated. Alternatively, the tubular body 15 can have an elliptical, in particular circular or non-circular, internal cross section as long as the tubular body 15 is situated in its unstressed state. This internal cross section can be compressed in the course of the pretensioning force being generated.

The battery pack 1 has, for example, at least one fluid duct 18, 18A, 18B through which temperature-control fluid TF can flow. The fluid duct 18, 18A, 18B can belong to a heat exchanger 17 of the battery pack 1. The heat exchanger 17 can be designed to temperature-control, in particular to cool, the at least one solid-state battery cell 3. The pretensioning device 8 delimits, for example, the at least one fluid duct 18, 18A, 18B at least in some regions. The pretensioning device 8 can delimit the fluid duct 18, 18A, 18B transversely to the stacking direction S at least in some regions, in particular only in some regions. The pretensioning device 8 can be a constituent part of the heat exchanger 17.

The battery pack 1 has, for example, at least two fluid ducts 18, 18A, 18B. The at least two fluid ducts 18, 18A, 18B can run substantially, in particular precisely, parallel to each other. The pretensioning device 8 delimits, for example, the at least two fluid ducts 18, 18A, 18B, in each case at least in some regions, in particular transversely to the stacking direction S.

Temperature-control fluid TF can flow through the at least two fluid ducts 18, 18A, 18B of the battery pack 1, for example in the manner of a parallel connection 19. Alternatively, temperature-control fluid TF can flow through the at least two fluid ducts 18, 18A, 18B in the manner of a series connection 20. In principle, it is contemplated that temperature-control fluid TF can flow through at least two fluid ducts 18, 18A, 18B of the battery pack 1 in the manner of a parallel connection 19, whereas temperature-control fluid TF can flow through at least two other fluid ducts 18, 18A, 18B of the battery pack 1 in the manner of a series connection 20.

The corrugated structure 12 can separate first fluid ducts 18, 18A of the battery pack 1 from second fluid ducts 18, 18B of the battery pack 1. The first fluid ducts 18, 18A and the second fluid ducts 18, 18B can be separated here from one another by means of the corrugated structure 12 in such a way that the first fluid ducts 18, 18A are defined by the troughs 13 and the second fluid ducts 18, 18B are defined by the crests 14.

The corrugated structure 12 can form a meandering course of fluid ducts 18, 18A, 18B.

The tubular body 15 of the pretensioning device 8 can, for example, delimit the fluid duct 18, 18A, 18B, in particular at least partially or completely. The internal cross section of the tubular body 15 can correspond to the internal cross section of the fluid duct 18, 18A, 18B.

The resilient element 10 or the heat exchanger 17 with such a resilient element 10 can serve to remove excess heat from the relevant solid-state battery cell 3. In particular, the relevant heat exchanger 17 can be used to actively cool the solid-state battery cell 3.

The housing 7 has, for example, a housing cover 21 which adjoins the housing interior 6. The housing cover 21 can adjoin the housing interior 6 at the end side. For example, the housing cover 21 adjoins the housing interior 6 perpendicular to the stacking direction S.

The housing cover 21 delimits, for example, a fluid distribution space 22, through which temperature-control fluid TF can flow, of the battery pack 1 at least partially, in particular substantially completely. The fluid distribution space 22 serves, for example, to distribute temperature-control fluid TF to the at least one fluid duct 18, 18A, 18B. The fluid distribution space 22 is, for example, designed to distribute temperature-control fluid TF to at least two fluid ducts 18, 18A, 18B of the battery pack 1. Alternatively or additionally, the housing cover 21 or another housing cover 23 of the housing 17 delimit a fluid collection space 24 of the battery pack 1 at least partially, in particular substantially completely. The fluid collection space 24 serves, for example, to collect temperature-control fluid TF from the at least one fluid duct 18, 18A, 18B. In particular, temperature-control fluid TF can be collected from at least two fluid ducts 18, 18A, 18B by means of the fluid collection space 24.

Temperature-control fluid TF can flow through the fluid collection space 24 and/or the fluid distribution space 22.

The wording “substantially completely delimited” can include locally present openings for the inlet and/or outlet of temperature-control fluid TF from the fluid collection space 24 and/or the fluid distribution space 22 and into the fluid collection space 24 and/or the fluid distribution space 22.

The housing cover 21 has, for example, an inlet opening 25. The inlet opening 25 can be designed for the throughflow of temperature-control fluid TF in order to feed temperature-control fluid TF to the at least one fluid duct 18, 18A, 18B. In particular, the inlet opening 25 can be arranged substantially in the center of the housing cover 21. Alternatively or additionally, the housing cover 21 or another housing cover 23 of the housing 7 can have an outlet opening 26. The outlet opening 26 can be designed for the throughflow of temperature-control fluid TF in order to discharge temperature-control fluid TF from the at least one fluid duct 18, 18A, 18B.

The battery pack 1 has, for example, a deflection device 27 through which temperature-control fluid TF can flow. The deflection device 27 here has a fluid inlet 28 for the inflow of temperature-control fluid TF into the deflection device 27. In addition, the deflection device 27 has a fluid outlet 29 for the outflow of temperature-control fluid TF from the deflection device 27. The fluid inlet 28 and the fluid outlet 29 communicate fluidically with each other.

The deflection device 27 is, for example, adapted to deflect temperature-control fluid TF when it flows through the deflection device 27 in such a way that an outlet temperature gradient AT of the temperature-control fluid TF flowing out at the fluid outlet 29 and an inlet temperature gradient ET of the temperature-control fluid TF flowing in at the fluid inlet 28 are oriented substantially in the same direction.

The outlet temperature gradient AT and the inlet temperature gradient ET are in particular oriented orthogonally to a main flow direction of the temperature-control fluid TF flowing through the deflection device 27. The main flow direction can be defined by a maximum flow rate of a flow profile of the temperature-control fluid TF flowing through the deflection device 27.

A volume unit of temperature-control fluid TF, which can be thought of in particular as a clot, which moves when it flows through the deflection device 27 in the main flow direction can, for example, have a flow cross section surface area oriented perpendicular to the main flow direction, wherein the flow cross section surface area is superimposed with a rotation, in particular by approximately 180°, when the volume unit moves in the main flow direction to the fluid outlet 29.

The main flow direction of the temperature-control fluid TF at the fluid outlet 29 is, for example, different, in particular substantially or precisely in an opposite direction to the main flow direction of the temperature-control fluid TF at the fluid inlet 28.

The housing cover 21 has, for example, the deflection device 27 through which temperature-control fluid TF can flow at least partially, in particular integrally and/or completely. Alternatively or additionally, the other housing cover 23 of the housing 7 can have the or a further deflection device 27.

The at least one fluid duct 18, 18A, 18B, for example, is fluidically joined to the fluid outlet 29 of the deflection device 27. Another, in particular second, fluid duct 18, 18A, 18B can fluidically join the fluid inlet 28.

The deflection device 27 has, for example, a U-shaped deflection fluid duct 34 through which temperature-control fluid TF can flow, in particular along the main flow direction. The deflection fluid duct 34 can extend in elongated fashion in a U-shape along the main flow direction.

The deflection device 27 has, for example, at least one, in particular a plurality of, duct wall surface portions 36. Such a duct wall surface portion 36 is designed, for example, substantially with a strip and/or band shape. The duct wall surface portion 36 extends in elongated fashion, for example, from the fluid inlet 28 to the fluid outlet 29 along a, in particular virtual or notional, U-shaped guide curve 35 of the deflection device 27. The duct wall surface portion 36 delimits the deflection fluid duct 34 partially, in particular orthogonally to the main flow direction of the temperature-control fluid TF flowing through the deflection device 27. The temperature-control fluid TF can flow along the duct wall surface portion 36 and consequently be deflected. Four duct wall surface portions 36 can be present which define a rectangular cross section, in particular a square cross section, of the deflection fluid duct 34.

The duct wall surface portion 36 can be designed in the manner of a Möbius strip portion. The deflection device 27 can expediently be referred to as a “Möbius strip mixer” for deflecting the temperature-control fluid TF by 180°.

The duct wall surface portion 36 has, for example, a twist, in particular about the guide curve 35, between the fluid inlet 28 and the fluid outlet 29. The twist is designed here such that temperature-control fluid TF flowing through the deflection fluid duct 34 is deflected as a result of the twist in such a way that the outlet temperature gradient AT and the inlet temperature gradient ET are oriented substantially in the same direction. In particular, the temperature gradient of a volume unit of the temperature-control fluid TF moving through the deflection device 27 as it flows through has a substantially constant angle to the duct wall surface portion 36.

The twist of the duct wall surface portion 36 can be an incomplete twist, in particular can be less than 360°. The twist is, for example, only an approximately half twist which can be between 150° and 210°, in particular approximately or precisely 180°.

The deflection device 27 can, for example, have at least one flow guidance element 38 for guiding the temperature-control fluid TF flowing through the deflection device 27. The at least one flow guidance element 38 protrudes from a duct wall surface 37, delimiting the deflection fluid duct 34, of the deflection device 27. Precisely one such flow guidance element 38 or at least two such flow guidance elements 38 can be provided. Such a flow guidance element 38 can be designed with a ridge and/or rib shape. A ridge-shaped flow guidance element 38 can continuously connect duct wall surface portions 36 situated opposite each other perpendicular to the main flow direction to one another. A rib-shaped flow guidance element 38 can, in particular in contrast, be integrally formed with a duct wall surface portion 36 and/or end freely, facing away from a duct wall surface portion 36.

The flow guidance element 38 can have a spiral which is twisted by 150° to 210°, in particular by approximately or precisely 180°. The spiral can run in the interior of the deflection fluid duct 34. In particular, the spiral can extend helicoidally through an interior of the deflection fluid duct 34, more particularly in the main flow direction.

The battery pack 1 has, for example, at least one further fluid duct 18*, 18A*, 18B* through which temperature-control fluid TF can flow. The at least one fluid duct 18, 18A, 18B and the at least one further fluid duct 18*, 18A*, 18B* flank the solid-state battery cell 3. The at least one further fluid duct 18*, 18A*, 18B* can belong to a further heat exchanger 17* of the battery pack 1. The at least one fluid duct 18, 18A, 18B is joined, for example, fluidically to the fluid outlet 29 of the deflection device 27, whereas the at least one further fluid duct 18*, 18A*, 18B* is fluidically joined to the fluid inlet 28 of the deflection device 27. The at least one fluid duct 18, 18A, 18B and the at least one further fluid duct 18*, 18A*, 18B* can communicate fluidically here with each other by means of the deflection device 27.

The heat exchanger 17 and the further heat exchanger 17* can be designed in similar fashion.

Bottom and top sides of successive corrugated structures 12 in the stacking direction S can be connected by a turn of the duct of the deflection device 27, in particular as a consequence of the twist and/or the spiral, in such a way that a warm side of the temperature-control fluid TF arrives at a cold side after the 180° deflection. The fluid ducts 18, 18A, 18B, 18*, 18A*, 18B* can be interconnected such that the temperature-control fluid TF flows substantially from inside to outside with respect to the whole battery pack 1.

The battery pack 1 is, for example, produced according to a method. This method has a step in which the cell assembly 2, pre-mounted in particular without pretension and/or loosely, is positioned between two housing parts 32 for the housing 7. The method has a further step in which the housing parts 32 are joined to one another in such a way that the housing interior 6 is at least partially delimited, holding the cell assembly 2 positioned between the housing parts 32, and that, along with the joining together of the housing parts 32, the minimum value for the pretensioning force is set and/or defined. The method moreover has a step in which the joined-together housing parts 32 are fastened to one another in such a way that the previously set or defined minimum value for the pretensioning force is preserved.

In the course of producing the battery pack 1, in order to set the pretensioning force, force measurement can be performed in particular only before and/or during the fastening of the housing parts 32 to one another. There is no need for a pressure sensor to be installed, in particular permanently, in the battery pack 1 itself.

The housing parts 32 can be fastened to one another by materially bonded connection of the housing parts 32 to one another. The materially bonded connection can be effected, for example, by adhesive bonding and/or by welding, in particular without filler metal. It should be understood that where appropriate other joining methods and/or combinations with other joining methods can be expedient for the fastening.

The housing parts 32 can surround the housing interior 6 in the manner of a shell and/or peripherally in their joined-together state, in particular in a fastened-together state. The housing parts 32 can be designed as shell housing parts and/or form a shell housing 32 of the housing 7 in their fastened-together state. The shell housing 33 can form a rectangular profile body.

The housing cover 21 of the housing 7 and/or the other housing cover 23 of the housing 7 can be fastened on the shell housing 33, for example at the end side. The housing parts 32 can be designed as identical parts and/or as L-shaped profile parts 31. Two L-shaped profile parts 31 can define the rectangular profile body of the shell housing 33, in particular in each case precisely half of it.

The shell housing 33 and/or at least one of the housing covers 21, 23 can have a polymer material or be made from a polymer material.

The temperature-control fluid TF can be air and/or a low-viscosity polyalphaolefin (PAO).

When a liquid is used as the temperature-control fluid TF, in some circumstances it may be conceivable to pump out the liquid from the battery pack 1 after the battery pack 1 has been charged with electricity or after an electric machining unit 1 has been operated on the basis of energy from the battery pack 1.

It can be conceivable to use air as the temperature-control fluid TF for operating the electric machining unit 110 with a held battery pack 1, whereas a liquid, in particular PAO, is used as the temperature-control fluid TF when the battery pack 1 is charged outside the electric machining unit 110. A tank for the liquid can be provided in an electric charging unit for charging the battery pack 1, wherein the charging unit has a pump which is designed to pump liquid through the battery pack 1 during the charging and which at the end of the charging pumps the liquid out again from the charged battery pack 1 such that, when the charged battery pack 1 is subsequently used in the electric machining unit 110, air can be reused as the temperature-control fluid TF.

The electric machining unit 110, the charging unit and/or the battery pack 1 of the machining system 100 can have the pump for conveying temperature-control fluid TF through the battery pack 1. A shell-and-tube heat exchanger which can dissipate heat removed from the battery pack 1 into the external environment can, for example, be provided in the charging unit and/or in the electric machining unit 110.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A battery pack for a machining system, comprising:
a housing delimiting a housing interior;
a cell assembly held in the housing interior,
wherein the cell assembly comprises:
at least one electric solid-state battery cell for storing electrical energy; and
a pretensioning device,
wherein the pretensioning device is configured to generate a pretensioning force acting on the solid-state battery cell such that the pretensioning force does not fall below a specified minimum value when the housing expands relative to the cell assembly.

2. The battery pack according to claim 1,
wherein the pretensioning device has at least one resilient element for generating the pretensioning force.

3. The battery pack according to claim 1,
wherein the battery pack has two contact plates for transmitting the pretensioning force, and
wherein a resilient element of the pretensioning device is sandwiched between the two contact plates.

4. The battery pack according to claim 1,
wherein at least one contact plate of the battery pack has a curvature and/or a structuring and/or a profiling for uniform distribution of pressure at a contact side of said contact plate.

5. The battery pack according to claim 1, wherein a resilient element of the pretensioning device has or is a corrugated structure.

6. The battery pack according to claim 1, wherein a resilient element of the pretensioning device has a tubular body.

7. The battery pack according to claim 1,
wherein the battery pack has at least one fluid duct through which a temperature-control fluid is flowable, and
wherein the pretensioning device delimits the at least one fluid duct at least in some regions.

8. The battery pack according to claim 1,
wherein the pretensioning device delimits at least two fluid ducts of the battery pack in each case at least in some regions, and/or
wherein temperature-control fluid is flowable through at least two fluid ducts of the battery pack either in a parallel connection or in a series connection manner.

9. The battery pack according to claim 1,
wherein the cell assembly has at least two solid-state battery cells,
wherein the at least two solid-state battery cells are arranged spaced apart from each other by a distance along a stacking direction of the cell assembly so as to flank a cell intermediate space of the cell assembly,
wherein the pretensioning device is sandwiched between the two solid-state battery cells flanking the cell intermediate space such that contact sides of the pretensioning device which are situated opposite each other along the stacking direction each touch one of the two solid-state battery cells.

10. A method for producing a battery pack which has a housing delimiting a housing interior, a cell assembly held in the housing interior, wherein the cell assembly includes at least one electric solid-state battery cell for storing electrical energy, and a pretensioning device, wherein the pretensioning device generates a pretensioning force acting on the solid-state battery cell such that the pretensioning force does not fall below a specified minimum value when the housing expands relative to the cell assembly,
wherein the method comprises the steps of:
positioning the cell assembly between two housing parts for the housing;
joining together the two housing parts such that the housing interior holding the positioned cell assembly is at least partially delimited, along with setting of the specified minimum value for the pretensioning force; and
fastening the joined-together housing parts to one another such that the set minimum value for the pretensioning force is preserved.

11. A battery pack for a machining system, comprising:
a cell assembly which has at least one electric solid-state battery cell for storing electrical energy; and
a deflection device through which temperature-control fluid is flowable and which has a fluid inlet for inflow of the temperature-control fluid into the deflection device, and a fluid outlet, communicating fluidically with the fluid inlet, for outflow of the temperature-control fluid from the deflection device,
wherein the deflection device is adapted to deflect the temperature-control fluid flowing through the deflection device such that an outlet temperature gradient of the temperature-control fluid flowing out at the fluid outlet and an inlet temperature gradient of the temperature-control fluid flowing in at the fluid inlet are oriented substantially in the same direction.

12. The battery pack according to claim 11,
wherein the deflection device has a U-shaped deflection fluid duct through which the temperature-control fluid is flowable.

13. The battery pack according to claim 11,
wherein the deflection device has at least one duct wall surface portion which extends in elongated fashion from the fluid inlet to the fluid outlet along a virtual, U-shaped, guide curve of the deflection device, and partially delimits a deflection fluid duct of the deflection device,
wherein the duct wall surface portion has a twist between the fluid inlet and the fluid outlet which is designed such that the temperature-control fluid flowing through the deflection fluid duct is deflected as a result of the twist in such a way that the outlet temperature gradient and the inlet temperature gradient are oriented substantially in the same direction.

14. The battery pack according to claim 11,
wherein the deflection device has at least one flow guidance element protruding from a duct wall surface, delimiting a deflection fluid duct of the deflection device, of the deflection device for guiding temperature-control fluid flowing through the deflection device.

15. The battery pack according to claim 11,
wherein a housing of the battery pack has a housing cover which adjoins a housing interior of the battery pack at an end side.

16. The battery pack according to claim 15,
wherein the housing cover at least partially delimits a fluid distribution space, through which the temperature-control fluid is flowable, for distributing the temperature-control fluid to at least one fluid duct of the battery pack, and/or
wherein the housing cover or another housing cover of the housing at least partially delimits a fluid collection space, through which the temperature-control fluid is flowable, for collecting temperature-control fluid from the at least one fluid duct of the battery pack.

17. The battery pack according to claim 15,
wherein the housing cover has an inlet opening for the throughflow of the temperature-control fluid which is to be fed to at least one fluid duct of the battery pack, and/or
wherein the housing cover or another housing cover of the housing has an outlet opening for the throughflow of the temperature-control fluid which is to be discharged from the at least one fluid duct of the battery pack.

18. The battery pack according to claim 15,
wherein the housing cover and/or another housing cover of the housing has at least part of the deflection device.

19. The battery pack according to claim 11,
wherein the battery pack has at least one further fluid duct through which temperature-control fluid is flowable, wherein the at least one fluid duct and the at least one further fluid duct flank the solid-state battery cell,
wherein the at least one fluid duct is fluidically joined to the fluid outlet of the deflection device and the at least one further fluid duct is fluidically joined to the fluid inlet of the deflection device such that the at least one fluid duct and the at least one further fluid duct communicate fluidically with each other via the deflection device.

20. A machining system, comprising:
a battery pack according to claim 1; and
an electric machining unit which comprises:
a holding device for replaceably holding the battery pack; and
an electric drive device which is supplied with electrical energy from the at least one solid-state battery cell of the held battery pack.
